(19) United States
(12) Patent Application Publication
(10) Pub. No.: US 2025/0363381 A1
(43) Pub. Date: Nov. 27, 2025

(54) MULTI-TURN REINFORCEMENT LEARNING FOR GENERATIVE MACHINE LEARNING MODELS

(71) Applicant: GDM Holding LLC, Mountain View, CA (US)

(72) Inventors: Lior Shani, Haifa (IL); Remi Munos, Le Vesinet (FR); Asaf Benjamin Cassel, Haifa (IL); Aviv Rosenberg, Tel Aviv (IL)

(21) Appl. No.: 19/216,508

(22) Filed: May 22, 2025

Related U.S. Application Data
(60) Provisional application No. 63/650,910, filed on May 22, 2024.

(51) Int. Cl. G06N 3/092; G06F 17/11; G06N 3/0475

(52) U.S. Cl. CPC G06N 3/092; G06F 17/11; G06N 3/0475

(57) ABSTRACT

Methods, systems, and apparatus, including computer programs encoded on a computer storage medium, for training a generative machine learning model using multi-turn training examples that include sequences of example inputs and example outputs. In one aspect, a method comprises, at each of a sequence of training iterations: obtaining a plurality of example interactions, wherein each example interaction includes example model inputs and example model outputs for a plurality of time steps; obtaining one or more reference interactions for each example interaction, wherein each reference interaction includes reference model inputs and reference model outputs for a plurality of time steps; determining a preference measure for each example interaction based on a comparison between the example interaction and the reference interactions for the example interaction; and updating the target generative machine learning model to optimize an objective function that includes the preference measures for the plurality of example interactions.

### CROSS-REFERENCE TO RELATED APPLICATION

This application claims priority to U.S. Provisional Application No. 63/650,910, filed on May 22, 2024. The disclosure of the prior application is considered part of and is incorporated by reference in its entirety in the disclosure of this application.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification generally describes a method for training a generative machine learning model using multi-turn training examples (e.g., training examples that include sequences of inputs to the generative machine learning model and corresponding outputs generated by the generative machine learning model).

According to one aspect, there is provided a method that includes: training a target generative machine learning model, the training comprising, at each of a sequence of training iterations: obtaining a plurality of example interactions for the training iteration, wherein each example interaction starts from a respective initial model input and comprises, for each of a plurality of time steps of the example interaction: (i) an example model input for the time step of the example interaction and (ii) an example model output for the time step of the example interaction; obtaining, for each example interaction of the plurality of example interactions, one or more reference interactions, wherein each of the one or more reference interactions for the example interaction starts from the same respective initial model input as the example interaction and comprises, for each of a plurality of time steps of the reference interaction: (i) a reference model input for the time step of the reference interaction and (ii) a reference model output for the time step of the reference interaction; determining, for each example interaction of the plurality of example interactions, a preference measure for the example interaction, wherein the preference measure for the example interaction is based on a comparison between the example interaction and the one or more reference interactions for the example interaction; and updating the target generative machine learning model using a machine learning technique to optimize an objective function, wherein the objective function includes the preference measures for the plurality of example interactions.

The target generative machine learning model can be configured to perform a machine learning task and the example interactions for training the target generative machine learning model can include example model inputs and example model outputs for performing the machine learning task. For example, the machine learning task can be a sequential machine learning task and the example interactions for training the target generative model can be example sequences of model inputs and example model outputs for performing the sequential machine learning task.

As one example, the machine learning task can involve interacting with a user to perform the task, e.g., by generating responses to queries received from the user. When the machine learning task involves interacting with a user, the example model inputs for an example interaction can include examples of queries from an example user and the example model outputs for the example interaction can include example responses to the examples of queries from the example user.

As another example, the machine learning task can be to select actions for an agent interacting with an environment to perform a task in the environment. The example model outputs for an example interaction can include example selected actions for an example agent to perform the task in an example environment for the example interaction. The example model inputs can include example observations of the example environment for the example interaction.

The subject matter described in this specification can be implemented in particular embodiments so as to realize one or more of the following advantages.

The described systems and methods enable more effective fine-tuning and alignment of generative models for multi-turn machine learning tasks (e.g., tasks in which the generative model interacts with an environment such as a user or another system over a sequence of timesteps or turns). Conventional fine-tuning methods, such as reinforcement learning from human feedback (RLHF), typically fine-tune generative models based on preferences between individual outputs from the models. In a multi-turn task, fine-tuning using preferences between individual outputs can often overemphasize generating individually preferred outputs that combine to form a less preferable multi-turn interaction. In contrast, the described systems can fine-tune generative models using preference measures that compare complete interactions for multi-turn tasks, which can avoid such an overemphasis of individual outputs. This can enable the described systems to more effectively train generative machine learning models to perform tasks that require multi-turn interactions to achieve a long-term goal as compared to conventional training methods.

The described systems can therefore enable improved fine-tuning of generative models for a variety of multi-turn machine learning tasks. As an example, the described systems can be used to fine-tune a generative model, such as a language model or an AI assistant, configured to interact with a user by engaging in a back-and-forth conversation using overall preferences for the resulting conversations with the user as opposed to preferences for individual responses generated by the generative model. As another example, the described systems can be used to fine-tune a generative model configured to select actions for an agent interacting with an environment over a sequence of time steps using overall preferences for resulting interactions between the agent and the environment as opposed to preferences for individual actions selected by the generative model.

By providing improved training of generative models for multi-turn tasks, the described systems can be used to reduce computational costs (e.g., computational time, memory usage, etc.) of training and inference for multi-turn machine learning tasks. For example, the described systems can be used to more efficiently train (e.g., using fewer training examples, over fewer training iterations, etc.) a same generative model to a desired level of performance in a multi-turn task as compared to conventional training methods. As another example, the described systems can be used to train a smaller, less complex generative model to attain a desired level of performance as compared to conventional training methods, which can further reduce computational costs of both training and inference of the model.

Additionally, implementations of the described systems can be used to perform offline training of generative models. For example, in some implementations, the described systems can determine preference measures comparing interactions for the multi-turn task by processing the interactions using a preference prediction machine learning model. The described systems can use, e.g., a language model that is prompted to compare interactions for the multi-turn task as the preference prediction machine learning model. This can enable the described systems to fine-tune generative models without interactively collecting human feedback, which can be computationally expensive, and can further reduce the computational costs of fine-tuning generative models.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example training system.

FIG. 2 illustrates generating an interaction using a machine learning model as part of performing a multi-turn machine learning task

FIG. 3 is a flow diagram of an example process for training a target generative machine learning model.

FIG. 4 is a flow diagram of an example process for updating a target generative machine learning model to optimize a reinforcement learning objective function

FIG. 5 illustrates a performance of example machine learning models that have been trained using the described methods.

Like reference numbers and designations in the various drawings indicate like elements.

### DETAILED DESCRIPTION

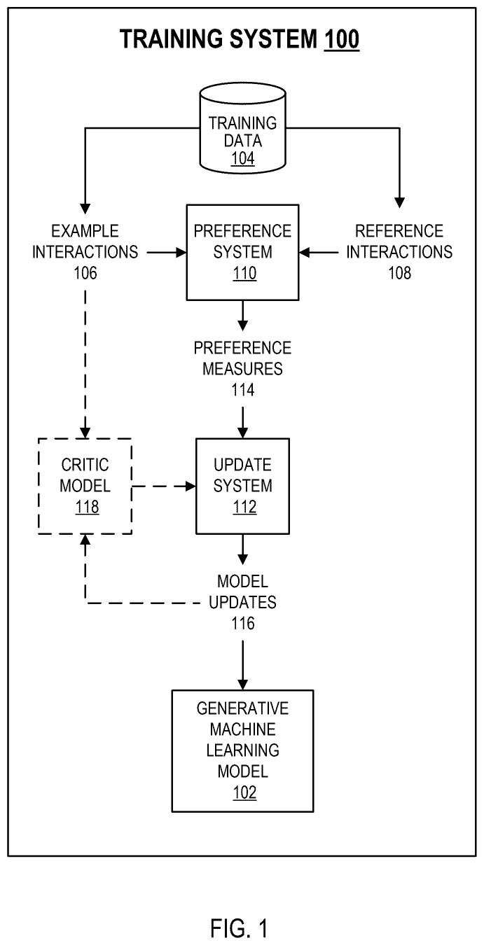

FIG. 1 shows an example training system 100. The training system 100 is an example of a system implemented as computer programs on one or more computers in one or more locations in which the systems, components, and techniques described below are implemented.

The training system 100 can train a generative machine learning model 102 (e.g., a target generative machine learning model) to perform a multi-turn machine learning task using a set of training data 104 for the multi-turn machine learning task.

The multi-turn machine learning task can be any of a variety of tasks that include processing a model input at each of a sequence of time-steps (e.g., “turns”) to generate a model output for each time-step. For example, the multi-turn machine learning task can include interacting with a user over a sequence of time-steps by processing a received query from the user as the model input at each time step to generate a corresponding response as the model output for the time step. As another example, the multi-turn machine learning task can include selecting actions for an agent interacting with an environment over a sequence of time steps to perform a task in the environment. As a further example, the machine learning task can include processing data characterizing the environment (e.g., data characterizing an observation of the environment) as the model input for each time step to generate a selected action for the agent as the model output for the time step.

The generative machine learning model 102 can have any appropriate architecture for processing the model inputs for the multi-turn machine learning task to generate the model outputs for the multi-turn machine learning task. In particular, the generative machine learning model 102 can be a neural network that includes any of a variety of processing layers (e.g., feedforward layers, convolutional layers, recurrent layers, attention layers, graph processing layers, etc.) in any appropriate combination for performing the multi-turn machine learning task.

For example, the generative machine learning model 102 can be a sequence processing neural network configured to generate output sequences (e.g., output token sequences) as model outputs for the multi-turn machine learning task by processing input sequences (e.g., input token sequences) as model inputs for the multi-turn machine learning task. As a further example, the generative machine learning model 102 can be an auto-regressive generative model (e.g., a Transformer, a recurrent neural network, etc.) that can auto-regressively generate output sequences. A transformer neural network is a neural network that includes a stack of transformer blocks, each typically including an attention or self-attention neural network layer, generally followed by a feedforward neural network layer (where a self-attention neural network layer applies a self-attention operation, e.g., QKV self-attention, to elements of an embedding, to update each element of the embedding).

The generative machine learning model 102 can, for example, be a large language model (LLM) that can generate tokenized representations of text data; a vision-language model (VLM) that can generate tokenized representations of image or video data, e.g., in response to a text input or that can generate tokenized representations of text, e.g., in response to an image input; an audio model that can input or generate tokenized representations of audio data; or a multimodal model that can generate output token sequences representing multiple modalities of data, e.g., two or more of text data, image data or audio data, e.g., in response to inputs characterizing input text, input images and input audio; and so on.

Generally, prior to the training of the generative machine learning model 102 by the system 100, the generative machine learning model 102 can have already been trained across one or more previous training stages.

For example, the one or more previous training stages can include a pre-training stage. During the pre-training stage, the generative machine learning model 102 can have been trained by the system 100 or a separate system on a next token prediction task, e.g., a task that requires predicting, given a current sequence of tokens, the next token that follows the current sequence in the training data.

As a particular example, the generative machine learning model 102 can have been trained on a maximum-likelihood objective on a large dataset of text in one or more natural languages, e.g., text that is publicly available from the Internet or another text corpus, a large dataset of computer code in one or more programming languages, e.g., Python, C++, C#, Java, Ruby, PHP, and so on, e.g., computer code that is publicly available from the Internet or another code repository, a large dataset of audio samples, e.g., audio recordings or waveforms that represent the audio recordings, a large dataset of images where each image includes an array of pixels, a large dataset of videos where each video includes a temporal sequence of frames, or a large multi-modal dataset that includes a combination of two or more of these datasets.

As another example, the one or more previous training stages can include one or more additional training stages, e.g., that occur after the pre-training stage. For example, the one or more previous training stages can include any one or more of: a supervised fine-tuning stage, a reinforcement learning stage, e.g., reinforcement learning from human or other feedback, a preference learning stage, an instruction tuning stage, and so on.

Such training of the generative machine learning model 102 over the one or more previous training stages can enable the training system 100 to more efficiently train the model 102 to perform the multi-turn machine learning task (e.g., using less training data, fewer training iterations, etc.).

The training system 100 can therefore fine-tune or align the generative machine learning model 102 using the training data 104 for the multi-turn machine learning task.

The training data 104 for the multi-turn machine learning task can include a plurality of example interactions 106 for the multi-turn machine learning task. Each of the example interactions 106 can include an example model input and an example model output for each of a plurality of time steps of the example interaction. Each of the example interactions 106 can include an initial model input for the example interaction that characterizes an initial state for the example interaction.

The training data 104 can include one or more reference interactions 108 for each of the example interactions 106. Each of the reference interactions 108 can include an initial model input for the reference interaction and can include a reference model input and a reference model output for each of a plurality of time steps of the reference interaction. Each of the reference interactions 108 can include an initial model input for the reference interaction that characterizes an initial state for the reference interaction.

In some cases, reference interactions 108 for a given example interaction can begin from different initial states than the given example interaction, e.g., by including initial model inputs that are different from the initial model input of the given example interaction. In other cases, the reference interactions 108 for a given example interaction can begin from a same initial state as the given example interaction, e.g., by each including a same initial model input as the given example interaction.

The system 100 can obtain the example interactions 106 and the reference interactions 108 for the multi-turn machine learning task from any of a variety of sources. For example, the example interactions 106 and/or the reference interactions 108 can include interactions from a human or a system (e.g., another machine learning model) performing the multi-turn task. As another example, the example interactions 106 and/or the reference interactions 108 can include simulated interactions generated by simulating the multi-turn task. As a particular example, when the multi-turn task includes processing queries from a user to generate responses for the queries, the example interactions 106 and/or the reference interactions 108 can include simulated sequences of queries and responses generated using a language model.

As another example, in some implementations, the training system 100 can generate the example interactions 106 and the reference interactions 108 as part of training the generative machine learning model 102. For example, in some implementations, the system 100 can generate the example interactions 106 using the generative machine learning model 102 while the system 100 trains the model 102. As another example, in some implementations, the system 100 can generate the reference interactions 108 using a reference machine learning model that has been configured (e.g., trained) to perform the multi-turn machine learning task.

The reference machine learning model can have any appropriate architecture for processing the model inputs for the multi-turn machine learning task to generate the model outputs for the multi-turn machine learning task. In particular, the reference machine learning model can be a neural network that includes any of a variety of processing layers (e.g., feedforward layers, convolutional layers, recurrent layers, attention layers, graph processing layers, etc.) in any appropriate combination for performing the multi-turn machine learning task.

As a particular example, the reference machine learning model can be the generative machine learning model 102 and the system 100 can generate the reference interactions 108 using the generative machine learning model 102. By generating both the example interactions 106 and the reference interactions 108 using the generative machine learning model 102, the system 100 can follow a self-play procedure to train the model 102 to attain better performance in the multi-turn machine learning task utilizing preferences between interactions generated by the model 102.

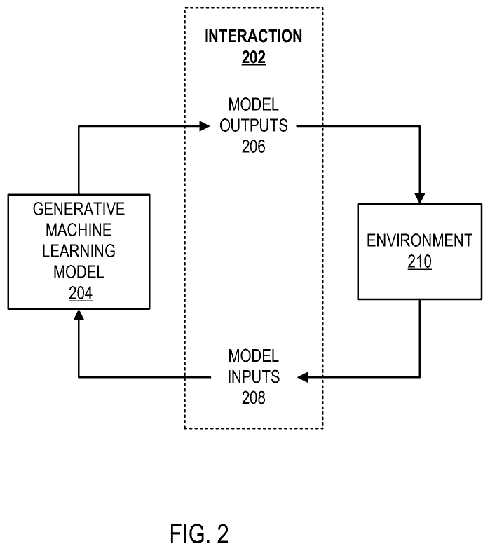

An example process by which the training system 100 can generate interactions for the multi-turn machine learning task using a machine learning model (e.g., using the generative machine learning model 102, using the reference machine learning model, etc.) is described in more detail below with reference to FIG. 2.

The training system 100 includes a preference system 110 and an update system 112, which are each described next (and throughout this specification).

The preference system 110 can process the example interactions 106 and the reference interactions 108 to determine preference measures 114 for the example interactions 106. The preference measure for each example interaction can measure a preference for the example interaction as compared with the one or more reference interactions for the example interaction. In particular, each example interaction and each reference interaction can include a respective final state and a preference measure for each example interaction can measure a preference for the final state of the example interaction as compared with the final states for the one or more reference interactions for the example interaction.

The final state for each interaction can include the model inputs and model outputs over each of the time steps for the interaction. By comparing such final states of the example interactions 106 and the reference interactions 108, the preference measures 114 for the example interactions 106 can characterize preferences for the example interactions 106 as a whole for the multi-turn machine learning task.

In some implementations, the preference system 110 can determine the preference measure for each example interaction by performing pairwise comparisons between the example interaction and each of the reference interactions for the example interaction. The system 110 can perform a pairwise comparison between an example interaction and a reference interaction to determine a preference score for the example interaction and the reference interaction that characterizes a probability that the example interaction is preferred over the reference interaction for performing the multi-turn machine learning task. The system 110 can determine the preference measure for each example interaction by combining (e.g., by averaging or computing a weighted sum of) the preference scores for the example interaction as compared to each of the reference interactions for the example interaction.

In some implementations, the preference measures 114 can characterize human preferences for the example interactions 106 compared to the reference interactions 108. When the preference measures 114 characterize human preferences, the preference measure for each example interaction can characterize a probability that a user prefers the example interaction over the reference interactions for the example interaction.

The preference system 110 can obtain data characterizing human preferences for the example interactions 106 and the reference interactions 108 by any of a variety of methods. For example, the preference system 110 can provide the example interactions 106 and the reference interactions 108 to one or more users and can receive human feedback for the example interactions 106 and the reference interactions 108 (e.g., feedback characterizing human ratings of the example and reference interactions, results of pairwise ratings between the example and reference interactions, etc.). As another example, the preference system 110 can process the example interactions 106 and the reference interactions 108 using a preference prediction machine learning model configured (e.g., trained) to predict human preferences between the example interactions 106 and the corresponding reference interactions 108. That is, the preference prediction machine learning model can be a model that has been trained (e.g., using a dataset that includes example pairs of interactions and human feedback for the example pairs of interactions) to process an example interaction and a reference interaction to determine a predicted probability that a user prefers the example interaction over the reference interaction for the multi-turn machine learning task.

In some implementations, the preference measures 114 can characterize performance metrics (e.g., rewards) attained by the example interactions 106 for the multi-turn machine learning task. For example, the preference measure for each example interaction can characterize a probability that the example interaction attains a better performance for the multi-turn machine learning task (e.g., as determined by a performance metric for the multi-turn machine learning task) as compared to the reference interactions for the example interaction.

The preference system 110 can determine the preference measures 114 based on any appropriate performance metrics (e.g., rewards) for the multi-turn machine learning task. For example, the performance metric for an interaction can be determined based on execution of one or more processes based on the model outputs of the interaction. For example, the model outputs for an interaction can include computer code in a programming language that, when executed by a computer, causes the computer to carry out a process and the performance metric for the interaction can be determined based on the execution of the process, e.g., based on whether the process was successfully executed to completion, based on metrics relating to the process such as memory usage, processing time, and so on. As another example, the model outputs for an interaction can include data representing actions to be taken by an agent (e.g., a mechanical agent such as a robot) and the performance metric for the interaction can be determined based on the execution of the actions, for example in a simulated environment or a real-world environment.

The update system 112 can train the generative machine learning model 102 by generating model updates 116 for the generative machine learning model 102 based on the preference measures 114 for the example interactions 106. In particular, the update system 112 can generate the model updates 116 for the generative machine learning model 102 to optimize an objective function that depends on the preference measures 114 for the example interactions 106.

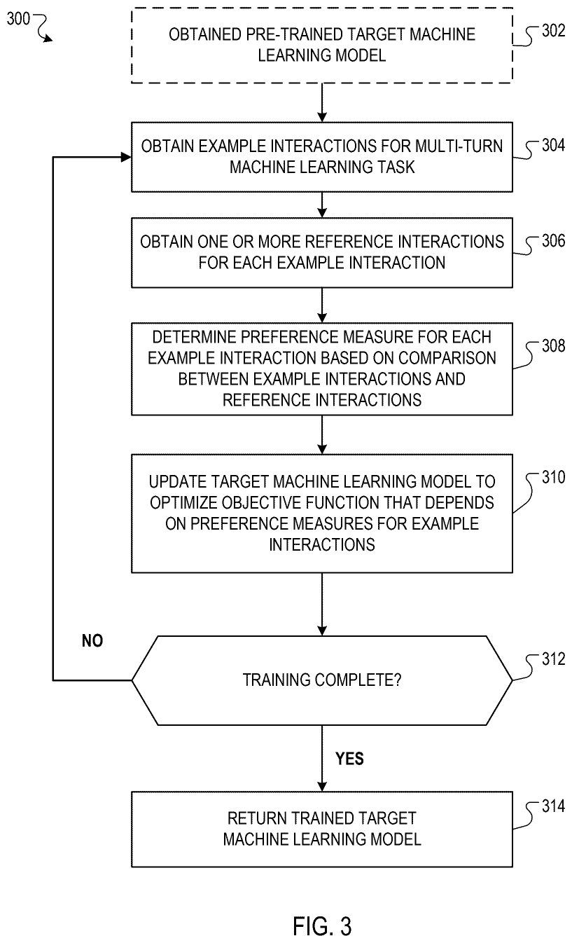

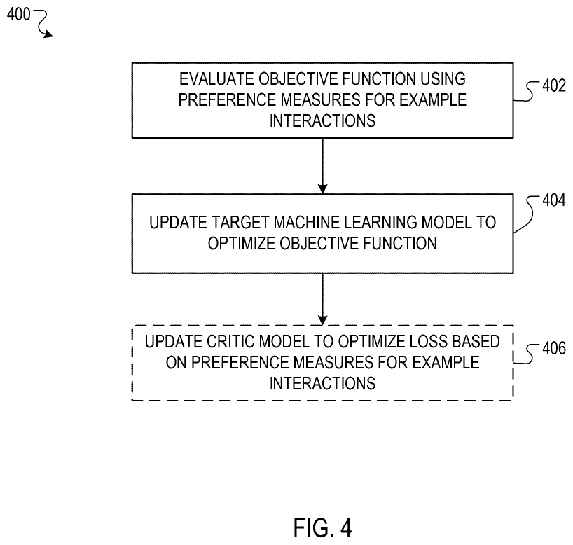

An example process and example objective functions the training system 100 can use to train the generative machine learning model 102 are described in more detail below with reference to FIG. 3 and FIG. 4.

As described below with reference to FIG. 4, the objective function can be a reinforcement learning objective function for any of a variety of reinforcement learning techniques. In some implementations, the system 100 can use an actor-critic reinforcement learning technique to train the generative machine learning model and the system 100 can include and train a critic model 118 for the multi-turn machine learning task.

The system 100 can evaluate the objective function for training the generative machine learning model 102 based, in part, on predicted values (e.g., expected preferences) for the example interactions 106 generated by the critic model 118.

The critic model 118 can have any appropriate architecture for processing the model inputs for example interactions for the multi-turn machine learning task to generate predicted values (e.g., expected preferences) for the example interactions. In particular, the critic model 118 can be a neural network that includes any of a variety of processing layers (e.g., feedforward layers, convolutional layers, recurrent layers, attention layers, graph processing layers, etc.) in any appropriate combination for processing the model inputs for example interactions for the multi-turn machine learning task to generate predicted values (e.g., expected preferences) for the example interactions. As described in more detail below with reference to FIG. 4, the system 100 can use the preference measures 114 as training data for training the critic model 118 to generate predicted values for the example interactions 106.

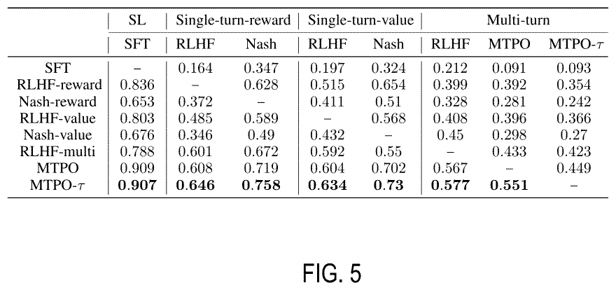

By utilizing preference measures between interactions that characterize preferences between overall final states of the interactions, the described systems can more effectively train the generative models to perform multi-turn machine learning tasks as compared to conventional training methods that rely on preferences between individual model outputs within the interactions. One example of the performance benefits conferred by using the described preference measures is shown below in FIG. 5.

After training by the training system 100, the target machine learning model 102 can be used to perform the multi-turn machine learning task by receiving and processing inputs for the task (e.g., from a user, another system, etc.) to generate outputs for the task, e.g., as described in more detail below with reference to FIG. 2.

FIG. 2 illustrates generating an interaction 202 using a generative machine learning model 204 as part of performing a multi-turn machine learning task.

As described above, a system (e.g., the training system 100 described above with reference to FIG. 1) can generate the interaction 202 over a sequence of time steps (e.g., turns) for the interaction 202 by processing model inputs 206 for the multi-turn machine learning task using the generative machine learning model 204 to generate corresponding model outputs 208 for the multi-turn machine learning task. For example, the machine learning model 204 can be a target generative machine learning model (e.g., the generative machine learning model 102 of FIG. 1) and a training system (e.g., the training system 100 of FIG. 1) can generate the interaction 202 as an example interaction (e.g., one of the example interactions 106 of FIG. 1) as part of training the generative machine learning model 204. As another example, the generative machine learning model 204 can be a reference machine learning model and a training system (e.g., the training system 100 of FIG. 1) can generate the interaction 202 as a reference interaction (e.g., one of the reference interactions 108 of FIG. 1) as part of training a target generative machine learning model (e.g., the generative machine learning model 102 of FIG. 1).

In particular, at each time step for the interaction 202, the system can receive input data for the time step from an environment 210 for the multi-turn machine learning task. The system can include the input data for the time step within a model input to the generative machine learning model 204 for the time step. The system can process the model input for each time step using the machine learning model 204 to generate the model output for the time step. The system can provide the model output generated by the model 204 to the environment 210, which can then produce input data for a next time step of the interaction 202 in response. In general, the model input for each time step can characterize a state of the interaction 202 as of the time step and can include input data received from the environment 210 and model outputs 208 generated by the model 204 at previous time steps of the interaction 202.

The environment 210 can produce input data for the interaction 202 in response to the model output 208 from the generative machine learning model 204 in any of a variety of ways. For example, in some cases, the environment 210 can include a user and the interaction 202 can be an interaction between the model 204 and the user. When the environment 210 includes a user, the system can (e.g., by way of user interface of the system) receive queries and responses from the user as the input data for the interaction 202 and provide responses from the generative machine learning model 204 as the model outputs 208 for the interaction 202. As another example, the environment 210 can include an external system and the interaction 202 can be an interaction between the model 204 and the external system. When the environment 210 includes an external system, the system can (e.g., by way of application programming interface of the system) receive requests or responses from the external system as the input data for the interaction 202 and provide requests or responses from the generative machine learning model 204 as the model outputs 208 for the interaction 202.

As another example, in some cases the multi-turn machine learning task can include selecting actions for an agent interacting with the environment 210. When the system generates the interaction 202 as part of selecting actions for an agent in the environment 210, the system can receive observations of the environment 210 the input data for the interaction 202 and provide data characterizing selected actions as generated by the generative machine learning model 204 as the model outputs 208 for the interaction.

As described above, a training system (e.g., the training system 100 of FIG. 1) can use the interaction 202 as an example interaction for training a target generative machine learning model to perform the multi-turn machine learning task. As part of using the interaction 202 as an example interaction for training the target generative machine learning model, the training system can determine a preference measure for the interaction 202 that can characterize, e.g., a human preference for the interaction 202 for the multi-turn machine learning task, a performance metric of the interaction 202 for the machine learning task, and so on.

In particular, the preference measure for the interaction 202 can characterize a preference (e.g., in relation to one or more reference interactions for the interaction) for a final state of the interaction 202. For example, in some implementations, the preference measure for the interaction 202 can be determined based on the model inputs 206 and the model outputs 208 for each of the time steps of the interaction 202. In other implementations, the preference measure for the interaction 202 can be determined based on a final state of the environment 210 at a final time step of the interaction 202.

Example multi-turn machine learning tasks and example architectures for the generative machine learning model 204 are described below.

In some implementations, the multi-turn machine learning task can include processing input prompts to generate output data items. The input prompts and the output data items can include any of a variety of modalities of data, e.g., text data, image data, audio data, structured numerical data, and so on. In some implementations, the input prompts and/or the output data items can include multi-modal data, e.g., data for multiple different modalities. The preference measure for the multi-turn machine learning task can characterize a quality or a perceived quality of the output data items. For example, the preference measure for the multi-turn machine learning task can be determined using, e.g., perceptual scores for the data items, human feedback regarding the data items, and so on. As another example, the output data items can be used as part of performing a downstream task and the preference measure for the multi-turn machine learning task can be determined using performance metrics for the downstream task as attained using the output data items.

In some implementations, the multi-turn machine learning task can be a reinforcement learning task that involves controlling an agent to perform one or more agent tasks while interacting with the environment 210. In the context of reinforcement learning, the machine learning model 204 can be considered to be a policy for the agent, the model inputs 206 can include observations of the environment 210 of the agent, and the model outputs 208 for the multi-turn machine learning task can characterize selected actions for the agent to perform the agent's tasks. The preference measure for the multi-turn machine learning task can be determined using rewards associated with performance of the agent tasks by the agent.

As described above with reference to FIG. 1, the generative machine learning model 204 can be a language model or vision language model neural network. In general, a (vision) language model neural network can be a neural network that has been trained so that, given a text prompt that includes a sequence of tokens in a natural language, the neural network can generate the next token in the sequence. This process can be repeated to extend the text prompt one token at a time to generate a natural language output, i.e., to generate the natural language output auto-regressively token by token. At each time “time step,” the language model neural network processes the current sequence to generate a probability distribution over a vocabulary of tokens. The next token can then be selected using the probability distribution, e.g., by sampling from the distribution using nucleus sampling or another sampling technique or by selecting the highest-probability token. The tokens in the vocabulary can include any of a variety of tokens, e.g., some combination of words, sub-words, characters, punctuation and other symbols, and numbers. In general, the language model neural network is trained on a corpus of text made up of tokens from the vocabulary (and optionally other tokens that can be mapped to a designated out-of-vocabulary token), to predict the next token in a sequence of tokens from the training data. The (vision) language model neural network can be an autoregressive Transformer neural network.

A (vision) language model neural network can be made to perform a particular task by providing a natural language description of the desired response as an input or “prompt” (input sequence). In some cases, the prompt can be a few-shot prompt where a few, e.g., 1 to 10, examples of a query and an example output are provided in the text prior to the actual query.

A (vision) language model neural network can be “fine-tuned” to perform a particular task, by obtaining a pre-trained language model neural network trained on a large corpus of examples as previously described and then further training part or all of the language model neural network on a relatively small number of examples particular to the type of task that is to be performed.

The generative machine learning model 204 can be a large language model neural network, e.g., one that has greater than 1 billion, 10 billion or 100 billion trained parameters. The generative machine learning model 204 can have been trained on greater than 10 billion, 100 billion or 1000 billion words or tokens representing words or other tokens.

The model inputs 206 and the model outputs 208 can be sequences of elements referred to herein as tokens. A “token” as used in this specification is a vector of numerical values having a specified dimensionality, i.e., the number of numerical values is constant across different tokens. Each token can include a respective predetermined or learned embedding (an ordered collection of numerical values having a pre-determined dimensionality.

In some implementations, the model inputs 206 and the model outputs 208 can include tokens representing text, e.g., words, wordpieces or characters, in a natural or computer language. For example, text can be received, e.g., as a series of encoded characters, e.g., UTF-8 encoded characters; such “characters” can include Chinese and other similar characters, as well as logograms, syllabograms and the like. A text encoder, i.e., a tokenizer, can process a sequence of text to represent the text as a series of text tokens from a vocabulary of text tokens, e.g., that each represent words, wordpieces or characters in a natural or computer language. The computer language can be any formal language used to communicate with a computer, e.g., a markup language, or a command or configuration language, or a data exchange language such as JSON, or a programming language. The tokenizer can, e.g., implement BPE (Byte Pair Encoding) or Wordpiece tokenization. Optionally the text can be obtained from audio data representing speech; the output tokens can be converted into audio data that represent speech corresponding to the text.

In some implementations, the model inputs 206 and the model outputs 208 can include image tokens representing images. Each image token can include a block encoding of values of the pixels in a different region of an image that maps a set of values of the pixels to a respective image token. The block encoding can be obtained using a neural network such as a Transformer neural network.

As used herein an image can be any still or moving image, i.e., the image can be part of a video, in 2D or 3D, and can be a monochrome, color or hyperspectral image, i.e., including monochrome or color pixels. As defined herein an “image” includes a point cloud, e.g., from a LIDAR system, and a “pixel” includes a point of the point cloud. An image can be captured by a camera or other image sensor from the real world; and objects in the image can include physical objects, represented by the image.

In some implementations, the model inputs 206 and the model outputs 208 can include tokens representing audio waveforms. For example, a set (sequence) of input or output tokens can represent audio data representing a waveform e.g., instantaneous audio amplitude values or time-frequency audio data. Each audio token can include a block encoding of the audio waveform in a different time segment of the audio that maps a set of values representing the audio waveform to a respective image token. The block encoding can be obtained using a neural network such as a Transformer neural network.

In a multimodal system audio data or an image can be flagged by a start-of-audio token or start-of-image token.

In some implementations the model inputs 206 can include tokens representing text, pixels of an image, or an audio waveform and the generative machine learning model 204 can generate the output sequence of tokens to perform tasks represented by the input sequence of tokens.

In some implementations the multi-turn machine learning task can include an image or audio generation task. The input sequences of tokens can then characterize images or audio to be generated, and the output sequences of tokens can include tokens defining images or audio waveforms characterized by the input sequences of tokens, e.g., text tokens.

In some implementations the multi-turn machine learning task can include an image or audio processing task. The input sequences of tokens can define image or audio inputs, and the output sequences of tokens can include tokens defining text that describes the image or audio inputs. As some examples, the multi-turn machine learning task can include a speech recognition task, an object or action detection task, a classification task, a captioning task, a question-answering task, or a character or word recognition task.

In some implementations the multi-turn machine learning task can include a multimodal processing task in which the input sequences of tokens and/or the output sequences of tokens can include multimodal data. For example, an input sequence of tokens can characterize both an image or audio input and a text input and a corresponding output sequence of tokens can include tokens defining a result of an image or audio processing task defined by the text, such as an open vocabulary classification or object detection task.

In general, multimodal data includes a combination of two or more different types of data, e.g., two or more of audio data, image data, text data, or graph data. As one example the multimodal data can include audio-visual data, comprising a combination of pixels of an image or of video and audio data representing values of a digitized audio waveform. As another example the multimodal data can include a combination of i) text data representing text in a natural language and ii) pixels of an image or of video or audio data representing values of an audio waveform.

Some examples of multimodal tasks include: open-vocabulary image classification (the output can classify the image input based on a text input comprising text descriptions of one or more classes in the image); open-vocabulary object detection (the output can detect one or more objects in the image input based on a text input comprising text descriptions of the one or more objects); image captioning (the output can comprise text that describes the image input); text-based image search (the output can identify from amongst multiple images in the image input one or more images that meet a text description of images to be retrieved, the text description being provided in a text input); image-based retrieval (the output can identify from amongst multiple images in the image input one or more images that match a further image in the image input), and so on. The multimodal processing tasks to be performed can be defined by text in the input sequences.

In some implementations the multi-turn machine learning task can include an agent control task in which the agent interacts with the environment 210 to perform the task. The agent can be a mechanical agent such a robot or (semi-) autonomous vehicle, interacting with a real-world environment to perform the task. The generative machine learning model 204 can be trained to control a simulated version of the agent in a simulated version of the environment 210 and then afterwards used to control the real agent in the real-world environment. The input sequence of tokens can include tokens that represent an observation of the environment 210, e.g., an image captured by a camera or other imaging device from a real-world environment. The output sequences of tokens comprises tokens that define one or more actions to be performed by the agent in the environment 210 in response to the observation.

In some implementations the generative machine learning model 204 can be stored on a user computing device, i.e., a device local to the user, such as a mobile device, e.g., a mobile phone, or a smart speaker.

In some implementations the generative machine learning model 204 can be implemented on a remote server in communication with a user computing device over a wired or wireless network communications link between the user computing device and the server.

The user computing device can be provided with an input mechanism, such as a text or voice interface, that enables user input from the user in a natural language. The user computing device can be provided with an output mechanism that provides a system output for the user in the or another natural language, e.g., as speech or text; or in some other way, e.g., by displaying an image. The input and output mechanisms can include, e.g., a keyboard, microphone, speaker, display, and/or camera.

As an example, the input mechanism can include a system configured to input audio data characterizing a speech waveform of speech representing the input from the user in a natural language, and a system configured to convert the audio data into tokens representing the speech in the natural language, e.g., representing a transcription of the spoken input. The output mechanism can include a system configured to receive tokens representing the output for the user in the or another natural language and a system configured to convert the received tokens into audio data representing a waveform of speech representing the output to the user in the natural language, i.e., representing spoken words.

As a further example, the generative machine learning model 204 can be deployed in an environment that enables a user to provide a request for the system, e.g., to process a multimodal input to generate a corresponding output sequence output. Users can provide requests, e.g., by way of a user interface or through an application programming interface (API). The request can be transmitted from a user device, e.g., over a data communications network such as the internet, to one or more computers implementing the system, e.g., in a data center. The system can generate a output sequence and then transmit the output sequence to a user device over a data communications network.

A user computing device can be provided, as an interface for the generative machine learning model 204, with an input mechanism that enables user input from the user in a natural language and an output mechanism that provides a system output to the user in the natural language. The input and output mechanism can include, e.g., a keyboard and display. Also or instead the input and output mechanism can include a speech-based mechanism. For example, the input mechanism can include a system configured to input audio data characterizing a speech waveform of speech representing the input from the user in the natural language and configured to convert the audio data into tokens representing the speech in the natural language, e.g., representing a transcription of the spoken input. The output mechanism can include a system configured to receive tokens representing the output to the user in the natural language and a system configured to convert the received tokens into audio data representing a waveform of speech representing the output to the user in the natural language, i.e., representing spoken words.

In some implementations the input sequences include one or more natural language statements relating to the environment 210, in particular a real-world environment, and include natural language requests relating to the environment 210. Similarly the output sequences can include natural language replies or natural language output statements that also relate to the environment 210, i.e., providing information relating to the environment 210, in some implementations relating to or specifying actions to be taken in the environment 210.

The generative machine learning model 204 can be used for diagnosing faults, or for correcting undesired behavior, in a mechanical or computing system operating in the real world environment. The model inputs 206 can include descriptions and/or images of observations of the mechanical or computing system, e.g., of operation of the system, optionally obtained from one or more sensors sensing a condition or operation of the system. An image observation can be converted into a text description, e.g., using an image captioning system or in other ways. The generated output sequences may include images, audio, or text that identify (describe) likely causes of the faults or undesired behavior. This can be used to repair the faults or correct the behavior. The preference measures for the multi-turn machine learning task can define relatively more useful types of output for repairing faults or correcting behavior, and other aspects of the responses as previously described.

The generative machine learning model 204 can be used for controlling a mechanical agent such as a robot or vehicle. For example, the model inputs 206 can include descriptions of tasks to be performed, and the generated output sequences can include lists of sub-tasks to be performed by the mechanical agent (trained to perform such sub-tasks), in order to perform the tasks. The preference measures for the multi-turn machine learning task can define relatively more preferable or useful types of sub-task, task safety, efficiency, and so on.

As another example, the environment 210 can be a computer security monitoring environment, e.g., the system can be deployed as part of a system that monitors the security of one or more computers. For example, the environment 210 can be a computer network security monitoring environment, and the system can be deployed as part of a system that monitors the security of one or more computers on a computer network, e.g., a wireless network, a cellular network, a local area network and/or the internet. As another example, the environment 210 can alternatively or additionally be a computer system security monitoring environment and the system can be deployed as part of a system that monitors the system for the presence of computer viruses and/or an unresolved software vulnerability, e.g., a zero-day exploit. A software vulnerability can be resolved by updating the software (e.g., patching) and/or removing (e.g., uninstalling) the software from the computer system. In these examples, the natural language requests can query whether computer security incidents have been resolved (e.g., “has the incident been resolved?”) and the model inputs 206 can include relevant statements from system logs, i.e., that are potentially relevant to the events being queried. A computer security incident can be, e.g., a data breach, an unauthorized log-in or other access of a secured system, a detection of a computer virus or detection of a software vulnerability. An incident can be “resolved” when the underlying incident is no longer a threat to the security of the computer system e.g., the computer virus has been removed, the access to the secured system has been removed, the data breach has been mitigated, or the software having the vulnerability has been updated or removed. The system can use the model inputs 206 to generate replies to the requests that include natural language statements indicating whether the incidents have been resolved, optionally displaying evidence used to determine this.

The model inputs 206 can include one or more of: code snippets from the software code, system logs, program logs, or other artifacts that should be left on the computer by running the program, or verification rules that represent requirements for the execution of the software program, or natural language statements describing the computer system on which the software executes. In general, the model inputs 206 can include relevant statements, i.e., statements that are potentially relevant to the events being queried.

In some implementations obtaining input data from the environment 210 can include obtaining, from the system logs, the data characterizing the computer network, or both, or from other data as described above, one or more observations of the computer network (which here includes computers on the network), and processing the one or more observations to generate a natural language representation of the one or more observations. The natural language requests can relate to the computer security incidents or to the secure operation of the computer network. The multi-turn machine learning task can include using the natural language representations of the one or more observations to provide one or more of the natural language statements describing the computer network, and using the natural language replies or the natural language output statements to identify a security status of the computer network or a security flaw in the computer network.

As another example, the environment 210 can be a software testing or evaluation environment, e.g., the system can be deployed as part of a system that tests software before deployment or that evaluates already-deployed software to identify bugs. In these examples, when the system tests software before deployment, the natural language requests can ask whether the software will execute as intended, and the model inputs 206 can include code snippets from the software code and, optionally, natural language statements describing the computer system on which the software will execute. The generative machine learning model 204 can process the model inputs 206 to generate replies that indicate whether the code will execute as intended, optionally displaying evidence used to determine this. When the system monitors the execution of code after deployment, the natural language requests can ask whether a software program, or a portion of a software program, has executed as intended, and the model inputs 206 can include one or more of: code snippets from the software code, system logs, program logs, or other artifacts that should be left on the computer by running the program, or verification rules that represent requirements for the execution of the software program, or natural language statements describing the computer system on which the software executes. The model 204 can then process the model inputs 206 to generate replies that indicate whether the code has executed as intended, optionally displaying evidence used to determine this. As a particular example, the software program can be part of the boot up of a computer, and the model 204 can generate a reply each time that the computer starts up to verify whether the computer will function correctly after start up.

As another example, the environment 210 can be an educational environment, e.g., the system can be deployed as part of an education software program that assists a user in learning or practicing one or more corresponding skills. In these examples, the model inputs 206 can include natural language statements describing or referencing a scenario or scene in a real-world or imagined environment, and the requests can be questions about the scenario or scene.

As another example, the environment 210 can be an information retrieval environment, e.g., the system can be deployed as part of a search engine or other software that allows a user to search for information in a corpus of documents, e.g., the Internet or another electronic document corpus. In these examples, the requests can be any appropriate natural language question, and the replies can optionally include evidence such as include relevant statements from the corpus of documents, e.g., as identified by searching the corpus using conventional information retrieval techniques.

In some implementations, the generative machine learning model 204 is a visual language model (VLM). In general, the VLM can process input sequences that include tokens that each represent natural language or (a part of) an image or video to generate output tokens that each represent natural language or (a part of) an image or video. For example, the VLM can be configured to describe an image or video using natural language, e.g., to perform an image or video captioning task. As another example, the VLM can be configured to process input tokens representing an image and text tokens representing a query about the image or a request to modifying the image, and to generate output tokens representing an answer to the query or representing a version of the image that has been modified in accordance with the request. The VLM can generate output tokens representing an image or video that is generated in response to input tokens providing a visual and/or audio and/or textual description of a desired image or video.

In some implementations, the “language” of the language model is not a natural language such (e.g., English), but can instead be a text-based encoding describing an entity or class of entities, e.g., a chemical or biological entity, such as a chemical structure or molecule. For example, the text-based encoding can be a sequence of tokens that defines a molecule or protein, e.g., a sequence specifying an arrangement of atoms or chemical functional groups in a molecule, or the amino acid residues of a protein. The language model can be referred to as a chemical and/or biological language model in such cases. The model inputs 206 therefore be input strings defining chemical (e.g., protein) structures and the model outputs 208 can include output strings defining different chemical structures from the input strings. The strings can be in the Simplified Molecular Input Line Entry System, SMILES, format, for example.

In another example of a computer language text generation task, a model input can include an image or video and a sequence of text in a computer language for performing a task in relation to the image or video, e.g., a data processing task that involves analyzing the content of the image or video to provide a result of the analysis or, e.g., a search to search for information relating to the content of the image or video. The computer language in the model output can include computer language for invoking a function or calling one or more external APIs. Merely as one example, such an output can be formatted as a JSON object. As previously, the sequence of text in a multimodal input can define the task to be performed and the second modality input can include, e.g., an image or video in relation to which the task is to be performed, e.g., a task that involves manipulation of particular types of data that may benefit from access to an API such as mathematical data, date/time related data, scientific data, recent data that may post-date training of the model (that can be accessed by a search function or API), and so on. After training, when the model is used in inference, the model output can include text in the or another computer language for performing a task, e.g., as described above, in relation to an image or video in the second modality input. The multi-turn machine learning task can then include using the text in the computer language to perform the task.

In some implementations, the generative machine learning model 204 can be used to interact with a human user of a digital assistant such as a smart speaker, smart display, or other device. For example, information defining a task can be obtained from the digital assistant, and the digital assistant can be used to instruct the user to perform the task. For example, this can include receiving, at the digital assistant, a request from the user for assistance and determining, in response to the request, a series of tasks for the user to perform, e.g., steps or sub-tasks of an overall task. Then for one or more tasks of the series of tasks, e.g., for each task, e.g., until a final task of the series the digital assistant can be used to output to the user an indication of the task, e.g., step or sub-task, to be performed. This can be done using natural language, e.g., on a display and/or using a speech synthesis subsystem of the digital assistant. Visual, e.g., video, and/or audio observations of the user performing the task can be captured, e.g., using the digital assistant. A system can then be used to determine whether the user has successfully achieved the task, e.g., step or sub-task, i.e., from the answer as previously described. If there are further tasks to be completed the digital assistant can then, in response, progress to the next task (if any) of the series of tasks, e.g., by outputting an indication of the next task to be performed. In this way a user can be led step-by-step through a series of tasks to perform an overall task.

As an illustrative example, a user can be interacting with a digital assistant and ask for help performing an overall task consisting of multiple steps, e.g., cooking a pasta dish. While the user performs the task, the digital assistant receives audio and/or video inputs representative of the user's progress on the task, e.g., images or video or sound clips of the user cooking. The digital assistant uses model 204 as described above, in particular by providing it with the captured audio and/or video and a question that asks whether the user has completed a particular step, e.g., ‘Has the user finished chopping the peppers?’, to determine whether the user has successfully completed the step. If the answer confirms that the user has successfully completed the step then the digital assistant progresses to telling the user to perform the next step or, if at the end of the task, or if the overall task is a single-step task, then the digital assistant may indicate this to the user. The digital assistant can then stop receiving or processing audio and/or video inputs to ensure privacy and/or reduce power use.

The digital assistant can also include a user interface to enable a user to request assistance and to output information. In implementations this is a natural language user interface and can include a keyboard, voice input-output subsystem, and/or a display. The digital assistant can further include an assistance subsystem configured to determine, in response to the request, a series of tasks for the user to perform. In implementations this can include a generative (large) language model, in particular for dialog. The digital assistant can have an observation capture subsystem to capture visual and/or audio observations of the user performing a task; and an interface for the above-described language model neural network (which may be implemented locally or remotely). The digital assistant can also have an assistance control subsystem configured to assist the user. The assistance control subsystem can be configured to perform the steps described above, for one or more tasks e.g., of a series of tasks, e.g., until a final task of the series. More particularly, the assistance control subsystem and output to the user an indication of the task to be performed, capture, using the observation capture subsystem, visual or audio observations of the user performing the task, determine from the above-described answer whether the user has successfully achieved the task. In response, the digital assistant can progress to a next task of the series of tasks and/or control the digital assistant, e.g., to stop capturing observations.

In some implementations, a particular task that is to be performed by the generative machine learning model 204 can be described by part or all of a sequence of text in an input to the model 204. For example, in a model input that includes an image such a prompt can specify, e.g., “Generate a caption”, “Generate a description”, “Answer the following question: [about the image or video]”, or “Detect a person”. Where the model 204 is used for an agent control task a prompt can define, e.g., “Take the knife out of the drawer”, or “Q: What action should the robot take to take the knife out of the drawer?”. Also or instead such a prompt can give one or more examples of a task to be performed. The model 204 can be trained on multiple natural and/or computer languages and the prompt may then specify a language to use.

A few further examples of some machine learning tasks that can be performed by a generative machine learning model 204 trained as described herein follow. The tasks described below can include tasks that require spatial awareness or other context from input images or video. For example, a prompt may ask “What is the object in the top left corner?”.

In general, for the tasks below the model 204 can have been trained or fine-tuned on examples of the input and output for the task. For example, the model 204 can have been trained using still or moving images containing one or more objects or actions, and corresponding sequences of text or other data e.g., describing or classifying the images. However large, “foundation” models can, in general, perform some tasks zero-shot, i.e., without having been specifically trained on those tasks.

As one example the task can include an object or action detection task. For example, a generated output sequence can include or represent text that describes or otherwise labels detected object(s) or action(s) in an input that includes an image or audio, and can include coordinates such as bounding-box coordinates for the detected object(s) or action(s), e.g., “10 20 90 100 cat 20 30 100 100 dog”.

As another example the task can include a classification task, e.g., an object or action classification task. A generated output sequence can include data, e.g., text, that classifies the object(s) or action(s) in represented in conditioning data, e.g., in an image or audio, into one of a plurality of classes, or that otherwise classify object(s) or action(s) represented in the conditioning data.

As another example the task can include a still or moving image describing task, e.g., a captioning task (which, as used here, includes an audio description task to explain what is happening in an image). A generated output sequence can include data, e.g., text, describing an input image or video. For example, a generated output sequence can provide a caption or description or it can count objects in the image or video, or it can provide some other form of description.

As another example the task can include a still or moving image question-answering task. A generated output sequence can include data, e.g., text, that answers a question about an input, e.g., an input image or audio, where the question is also specified in the input, e.g., as sequence of text. This may be used, e.g., to answer questions about visual plots and charts or about sounds.

As another example the task can include a character or word recognition task, e.g., an OCR (optical character recognition) task. An input can include a still or moving image and a generated output sequence can include text that represents characters or words in the input, e.g., in a natural language.

As another example the task can include a still or moving image generation task. A generated output sequence can include image data defining values for pixels of a still or moving image, and an input, e.g., a sequence of text, may describe or characterize the image to be generated. Merely as an example, an image of a plot or chart can be generated to represent the input, e.g., comprising text.

As another example the task can include a computer language text generation task. An input can include a natural language description of a task to be performed, and optionally an image (if the task is to be performed on or in relation to an image), and a generated output sequence can include text in a computer language to perform the task, e.g., a task of analyzing the content of the image to provide a result of the analysis or to search for information relating to the content of the image.

As a particular example the computer language in a generated output sequence can include computer language for invoking a function or calling one or more external APIs. Merely as one example, such an output sequence can include data formatted as a JSON object. As previously, an input can define a task to be performed and can also include an image in relation to which the task is to be performed. In general the task can involve manipulation of particular types of data that can benefit from access to an API such as mathematical data, date/time related data, scientific data, recent data that may post-date training of the model 204 (that can be accessed by a search function or API), and so on; and the generated output sequence can include text in a computer language for performing the task. The multi-turn machine learning task can include using the text in the computer language to perform the task.

In general where a generated output sequence includes text, such text can be converted to speech representing the text, and an audio (speech) output provided.

In some implementations the task can include an agent control task in which the agent interacts with the environment 210 to perform the agent control task. In these implementations an input can include an observation characterizing the environment 210. For example, an input can include a sequence of text that defines a task to be performed by the agent and an image representing an observation of the environment 210, e.g., captured by a camera or other imaging device from a real-world environment. A generated output sequence can include an action selection output, e.g., including text, that is used to select one or more actions to be performed by the agent in the environment 210 in response to the observation. As an illustration the generated output sequence can define an action as text such as “A: 132 114 128 5 25 156”, that can be converted into a control signal for a mechanical agent, such as a robot, e.g., “ΔT=[0.1, −0.2, 0] ΔR=[10°, 25°, −7°]”. The action selection output can also or instead define one or more low-level skills, e.g., from a vocabulary of previously learnt skills. As before, a sequence of text in a model input can describe the task to be performed, e.g., “What action should the robot take to [perform task]”. Examples of systems for controlling an agent that can be fine tuned as described herein can include PaLM-E (Driess, et al., arXiv: 2303.03378), RT-1 (Brohan, et al., arXiv: 2212.06817), and RT-2 (Brohan, et al., arXiv: 2307.15818).

In some agent control implementations, the environment 210 is a real-world environment and the agent is a mechanical agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent can be a robot or other mechanical agent interacting with the environment 210 to accomplish a specific task, e.g., to locate or manipulate an object of interest in the environment or to move an object of interest to a specified location in the environment or to navigate to a specified destination in the environment. In these implementations, the observations can include, e.g., one or more of: images, object position data, and sensor data to capture observations as the agent interacts with the environment. The actions can define control signals to control the robot or other mechanical agent, e.g., positions, torques, or other control signals for the parts of the mechanical agent, or higher-level control commands.

In some agent control implementations the agent can be a human agent and the environment 210 can be a real-world environment. For example, the agent can be a human user of a digital assistant such as a smart speaker, smart display, or some other device that is used to instruct the user to perform actions. The task can include any real-world task that the user wishes to perform. The observations can be obtained from an observation capture subsystem, e.g., a monitoring system such as a video camera or sound capture system, to capture visual observations of the user performing the task. The actions can include instructions in the form of, e.g., text, image, video, or audio data such as speech, that guide the user in performing the task.

The described systems and techniques can be applied to a wide range of different types of input sequences and output sequences. In implementations of the described techniques the tokens can represent, characterize, or encode any type of information in a sequence, e.g., stream of data. The term “represent” is used, below, generally to refer to any way in which a token can encode part of a sequence. The tokens may include marker tokens, such as a start of sequence token, an end of sequence token, and a separator token (indicating a separation or break between two distinct parts of a sequence). The tokens may, but need not be, drawn from a defined vocabulary of tokens.

Some of these implementations can be used for natural language tasks such as providing a natural language response to a natural language input, e.g., for question answering, or for text completion. In some implementations the input sequence can represent text in a natural language and the output sequence may represent text in the same natural language, e.g., a longer item of text. For example, in some implementations the input sequence can represent text in a natural language and the output sequence may represent the same text with a missing portion of the text added or filled in. For example, the output sequence can represent a predicted completion of text represented by the input sequence. Such an application can be used, e.g., to provide an auto-completion function, e.g., for natural language-based search. In some implementations the input sequence can represent a text in a natural language, e.g., posing a question or defining a topic, and the output sequence can represent a text in a natural language which is a response to the question or about the specified topic.

As another example the input sequence can represent a first item of text and the output sequence can represent a second, shorter item of text, e.g., the second item of text can be a summary of a passage that is the first item of text. As another example the input sequence can represent a first item of text and the output sequence can represent an aspect of the first item of text, e.g., it can represent an entailment task, a paraphrase task, a textual similarity task, a sentiment analysis task, a sentence completion task, a grammaticality task, and in general any natural language understanding task that operates on a sequence of text in some natural language, e.g., to generate an output that classifies or predicts some property of the text. For example, some implementations can be used to identify a natural language of the first item of text, or of spoken words where the input is audio (as described below).

Some implementations can be used to perform neural machine translation. Thus in some implementations the input tokens can represent words, wordpieces, or characters in a first natural language and the output tokens can represent words, wordpieces or characters in a second, different natural language. That is, the input sequence can represent input text in the first language and the output sequence can represent a translation of the input text into the second language.

Some implementations can be used for automatic code generation. For example, the input tokens can represent words, wordpieces or characters in a first natural language and the output tokens can represent instructions in a computer programming or markup language, or instructions for controlling an application program to perform a task, e.g., build a data item such as an image or web page.

Some implementations can be used for speech recognition. In such applications the input sequence can represent spoken words and the output sequence can represent a conversion of the spoken words to a machine-written representation, e.g., text. Then the input tokens can include tokens representing an audio data input including the spoken words, e.g., characterizing a waveform of the audio in the time domain or in the time-frequency domain. The output tokens can represent words, wordpieces, characters, or graphemes of a machine-written, e.g., text, representation of the spoken input, that is representing a transcription of the spoken input.

Some implementations can be used for handwriting recognition. In such applications the input sequence can represent handwritten words, syllabograms or characters and the output sequence may represent a conversion of the input sequence to a machine-written representation, e.g., text. Then the input tokens can include tokens representing portions of the handwriting and the output tokens can represent words, wordpieces, characters or graphemes of a machine-written, e.g., text, representation of the spoken input.

Some implementations can be used for text-to-speech conversion. In such applications the input sequence can represent text and the output sequence can represent a conversion of the text to spoken words. Then the input tokens can include tokens representing words or wordpieces or graphemes of the text and the output tokens can represent portions of audio data for generating speech corresponding to the text, e.g., tokens characterizing a portion of a waveform of the speech in the time domain or in the time-frequency domain, or phonemes.

Some implementations can be used for a genomics task, where the input sequence represents a fragment of a DNA sequence or other molecule sequence and the output sequence is either an embedding of the fragment for use in a downstream task, e.g., by making use of an unsupervised learning technique on a data set of DNA sequence fragments, or an output for the downstream task. Examples of downstream tasks include promoter site prediction, methylation analysis, predicting functional effects of non-coding variants, and so on.

In some cases, the multi-turn machine learning task is a combination of multiple individual machine learning tasks, i.e., the model 204 can be configured to perform multiple different individual machine learning tasks, e.g., two or more of the machine learning tasks mentioned above. For example, the model 204 can be configured to perform multiple individual natural language understanding tasks, with the model inputs 206 including an identifier for the individual natural language understanding task to be performed on the model inputs 206.

In some implementations the input sequence and the output sequence represent different modalities of input. For example, the input sequence can represent text in a natural language and the output sequence can represent an image or video corresponding to the text; or vice-versa. In general, the tokens can represent image or video features and a sequence of such tokens can represent an image or video. There are many ways to represent an image (or video) using tokens. As one example an image (or video) can be represented as a sequence of regions of interest (RoIs) in the image, optionally including one or more tokens for global image features. For example, an image can be encoded using a neural network to extract Rol features; optionally (but not essentially) a token can also include data, e.g., a position encoding, representing a position of the Rol in the image. As another example, the tokens can encode color or intensity values for pixels of an image. As another example, some image processing neural network systems, e.g., autoregressive systems, naturally represent images as sequences of image features. As another example, a transformer-based sequence processing neural network system as previously described can be used to process images instead of or as well as text (e.g., if trained on images instead of or as well as text).

Thus in some implementations at least one of the input sequence and the output sequence is a sequence representing an image or video and can include tokens representing the image or video. For example, the input sequence can be a sequence of text, the input tokens can represent words, wordpieces, or characters and the output sequence can include output tokens representing an image or video, e.g., described by the text, or providing a visual answer to a question posed by the text, or providing a visualization of a topic of the text. In another example the input sequence can include a sequence of input tokens representing an image or video, and the output tokens can represent words or wordpieces, or characters representing text, e.g., for a description or characterization of the image or video, or providing an answer to a question posed visually by the image or video, or providing information on a topic of a topic of the image or video.

In some other implementations both the input sequence and the output sequence can represent an image or video, and both the input tokens and the output tokens can represent a respective image or video. In such implementations the method/system can be configured to perform an image or video transformation. For example, the input sequence and the output sequence can represent the same image or video in different styles, e.g., one as an image the other as a sketch of the image; or different styles for the same item of clothing.

In some implementations the input sequence represents data to be compressed, e.g., image data, text data, audio data, or any other type of data; and the output sequence a compressed version of the data. The input and output tokens can each include any representation of the data to be compressed/compressed data, e.g., symbols or embeddings generated/decoded by a respective neural network.

In some implementations the input sequence represents a sequence of actions to be performed by an agent, e.g., a mechanical agent in a real-world environment implementing the actions to perform a mechanical task. The output sequence can include a modified sequence of actions, e.g., one in which an operating parameter, such as a speed of motion or power consumption, has a limited value; or one in which a safety limit or other boundary is less likely to be crossed. Then both the input tokens and the output tokens may represent the actions to be performed.

In some implementations the input sequence represents a sequence of health data and the output sequence can include a sequence of predicted treatment. Then the input tokens can represent any aspect of the health of a patient, e.g., data from blood and other medical tests on the patient and/or EHR (Electronic Health Record) data; and the output tokens can represent diagnostic information, e.g., relating to a disease status of the patient and/or relating to suggested treatments for the patient, and/or relating to a likelihood of an adverse health event for the patient.

As a particular example the model 204 can be a multimodal model neural network in which one or both of the model input (i.e., input sequence) and the model output (i.e., output sequence) include an image or audio. For example the multimodal machine learning model can be configured to process an input sequence including visual tokens representing pixels of a still or moving image (which here may include a point cloud image), and/or data representing an audio waveform, e.g., values or features of the audio waveform such as audio tokens, and/or text tokens representing a sequence of text, to generate an output sequence, e.g., including text tokens representing the still or moving image or audio waveform, and/or a sequence of intensity value inputs for the pixels of an image or a sequence of values defining an audio waveform. A visual token can, e.g., represent multiple pixels in a region of the image, e.g., as features of the region. Such a multimodal model 204 can perform any of the previously described tasks, e.g., using a multimodal input, or by providing a multimodal output, or by converting between different input and output modes (e.g., text/image/audio). For example, it can generate text representing, describing (e.g., captioning), or otherwise characterizing an image or audio input, e.g., by answering a question related to the image or audio input, e.g., relating to a future, e.g., physical prediction of a state of objects represented by the image or audio. As another example it can generate an image or audio represented, described, or otherwise characterized by a text input, or otherwise in response to the text input, e.g., representing an image or audio answer to a text question.

FIG. 3 is a flow diagram of an example process for training a target generative machine learning model to perform a multi-turn machine learning task. For convenience, the process 300 will be described as being performed by a system of one or more computers located in one or more locations. For example, a training system, e.g., the training system 100 of FIG. 1, appropriately programmed in accordance with this specification, can perform the process 300.

In some implementations, the target generative machine learning model can be pre-trained to perform one or more pre-training tasks and the system can obtain the pre-trained target generative machine learning model before training the target generative machine learning model to perform the multi-turn machine learning task (step 302). The system can obtain the pre-trained target generative machine learning model by any of a variety of methods. For example, in some implementations, the target generative machine learning model can be pre-trained to perform the pre-training tasks by another training system and the system can receive data specifying the pre-trained target generative machine learning model from the other training system. As another example, in some implementations, the system itself can, before training the target generative machine learning model to perform the multi-turn machine learning task, pre-train the target generative machine learning model to perform the one or more pre-training tasks using training data for the pre-training tasks.

The system can train the target generative machine learning model over a sequence of training iterations. As part of training the target generative machine learning model, the system can perform steps 304 through 312 at each training iteration.

At each training iteration, the system can obtain a plurality of example interactions for the multi-turn machine learning task (step 304). Each example interaction can include an example model input and an example model output for each of a plurality of time steps (e.g., turns) of the example interaction. Each example interaction can include an initial model input for the example interaction (e.g., an initial model input for a first time step of the example interaction). The initial model input for each example interaction can characterize an initial state for the example interaction.

As described above, the example model inputs and the example model outputs can include any of a variety of modalities of data, e.g., text data, image data, audio data, structured numerical data, and so on. In some implementations, the example model inputs and/or the example model outputs can include multi-modal data, e.g., data for multiple different modalities.

In some implementations, the multi-turn machine learning task can involve interacting with a user to perform the task, e.g., by generating responses to queries received from the user.

When the multi-turn machine learning task involves interacting with a user, each example interaction can include example model inputs characterizing example queries from an example user and example model outputs characterizing example responses to the example queries for each time step of the example interaction.

In some implementations, the multi-turn machine learning task can involve selecting actions for an agent interacting with an environment to perform a task in the environment. Each example interaction can include example model inputs characterizing example observations of an example environment and example model outputs characterizing example selected actions for an example agent for each time step of the example interaction.

The system can obtain the example interactions by any of a variety of methods. For example, in some implementations, the system can retrieve the example interactions from a database of training data for the multi-turn machine learning task that includes a plurality stored interactions for the multi-turn machine learning task. The stored interactions for the multi-turn machine learning task can include demonstration examples for the multi-turn task, e.g., from humans performing the multi-turn task, from one or more machine learning models performing the machine learning task, and so on.

As another example, at each training iteration, the system can generate the example interactions for the training iteration by using the target generative machine learning model to perform the multi-turn machine learning task, as described in more detail above with reference to FIG. 2.

In some implementations, the system can obtain each example interaction as a portion of a corresponding source interaction (e.g., a source interaction retrieved from a database of demonstration examples, a source interaction generated using the target generative machine learning model, etc.).

The system can obtain one or more reference interactions for each example interaction for the training iteration (step 306). Each reference interaction can include a reference model input and a reference model output for each of a plurality of time steps (e.g., turns) of the reference interaction.

Each reference interaction can include an initial model input for the reference interaction (e.g., an initial model input for a first time step of the reference interaction). The initial model input for each reference interaction can characterize an initial state for the reference interaction.

In some cases, the reference interactions for each example interaction can begin from different initial states than the example interaction, e.g., by including initial model inputs that are different from the initial model input of the example interaction. In other cases, the reference interactions for each example interaction can begin from a same initial state as the example interaction, e.g., by each including a same initial model input as the example interaction.

The system can obtain the reference interactions by any of a variety of methods. For example, in some implementations, the system can retrieve the reference interactions from a database of demonstration examples for the multi-turn machine learning task. As another example, at each training iteration, the system can generate the reference interactions for the training iteration by using a reference machine learning model to perform the multi-turn machine learning task, as described in more detail above with reference to FIG. 2.

In some implementations, to train the target generative machine learning model following a self-play process, the reference machine learning model can be the target generative machine learning model and the system can generate the reference interactions using the target generative machine learning model.

In some implementations, the system can obtain each reference interaction as a portion of a corresponding source interaction (e.g., a source interaction retrieved stored within a database of demonstration examples, a source interaction generated using the reference machine learning model, etc.).

The system can determine a preference measure for each example interaction for the training iteration based on a comparison between the example interaction and the one or more reference interactions for the example interaction (step 308). The preference measure for each example interaction can be determined based on a comparison of a final state for the example interaction with final states of the one or more reference interactions for the example interaction, which can enable the preference measure to characterize an overall preference for the example interaction for the multi-turn machine learning task. The final states for each example interaction and each reference interaction can include or depend on the model inputs and model outputs for each time step of the interaction.

In general, the preference measure for each example interaction can characterize a probability that the final state of the example interaction is preferred for the multi-turn machine learning task compared to the final states of the reference interactions for the example interaction.

For example, the preference measure for each example interaction can characterize a human preference for the example interaction, e.g., by measuring a probability that a user prefers the example interaction to the reference interactions for the example interaction. As another example, the preference measure for each example interaction can characterize a performance of the example interaction for the multi-turn machine learning task, e.g., by measuring a probability that the example interaction attains a greater task reward or performance metric for the multi-turn machine learning task compared to the reference interactions.

The system can obtain data characterizing comparisons of the example interactions with corresponding reference interactions by any of a variety of methods. For example, a database of example demonstrations for the multi-turn machine learning task can include, e.g., human feedback, task rewards, performance metrics, and so on for interactions stored within the database and the system can retrieve such data as part of retrieving the example and reference interactions from the database of example demonstrations.

As another example, the system can provide the example and reference interactions to one or more users and can receive human feedback from the one or more users for the example and reference interactions. The human feedback from the one or more users can include, e.g., ratings or scores assigned to the example and reference interactions, rankings of the example interactions and corresponding reference interactions, results of pair-wise comparisons of the example interactions with corresponding reference interactions, and so on.

As another example, the system can process the example and reference interactions using a preference prediction machine learning model configured to model human preferences for the multi-turn machine learning task. For example, the preference prediction machine learning model can be a reward model for the multi-turn machine learning task that has been trained to process data characterizing interactions for the multi-turn task to predict human rankings or ratings for the interactions. As another example, the preference prediction machine learning model can be a generative machine learning model (e.g., a language model) configured to process data characterizing interactions for the multi-turn task to generate feedback for the interactions.

The preference prediction machine learning model can be configured to process data characterizing a pair of interactions for the multi-turn machine learning task to generate a predicted preference between the pair of interactions. The system can determine the preference measure for each example interaction using the preference prediction machine learning model to perform pair-wise comparisons of the example interaction with each of the reference interactions for the example interaction. Specifically, for each example interaction and each reference interaction for the example interaction, the system can process data characterizing the example interaction and the reference interaction using the preference prediction machine learning model to determine a predicted preference between the example interaction and the reference interaction. In some implementations, e.g., when the preference prediction machine learning model is a language model, the system can provide an input prompt to the preference prediction machine learning model for processing each pair of example and reference interactions, e.g., an input prompt that includes a request to predict a preference between the example interaction and the reference interaction.

The system can update the target generative machine learning model to optimize an objective function for the multi-turn machine learning task that includes the preference measures for the plurality of example interactions (step 310). By including the preference measures for the plurality of example interactions, the objective function for the multi-turn machine learning task can measure an overall preference for interactions generated by the target generative machine learning model. This can enable the system to update the target generative machine learning model to optimize an overall preference for complete interactions generated using the target generative machine learning model, which can improve performance for the multi-turn machine learning task as compared to optimizing preferences for individual outputs generated by the target generative machine learning model (e.g., as performed following conventional training methods).

The system can update parameters of the target generative machine learning model using any appropriate machine learning technique to optimize the objective function for the multi-turn machine learning task. In particular, the system can utilize any of a variety of reinforcement learning techniques to update the target generative machine learning model. Example objective functions and methods of updating the parameters of the target generative machine learning model for various example reinforcement learning techniques are described in more detail below with reference to FIG. 4.

The system can determine whether training is complete (step 312). The system can use any of a variety of criteria to determine whether the training is complete. For example, the system can determine that training is complete after a pre-determined number of training iterations. As another example, the system can determine that training is complete when a value of the objective function falls below a pre-determined threshold. As another example, the system can determine that training is complete when a difference between values of the objective function for the current training iteration and a previous training iteration falls below a pre-determined threshold.

If the system determines that training is not complete, the system can continue to a next training iteration (e.g., return to step 304)

When the system determines that the training is complete, the system can return the trained target generative machine learning model (step 314).

FIG. 4 is a flow diagram of an example process for updating a target generative machine learning model to optimize a reinforcement learning objective function for a multi-turn machine learning task. For convenience, the process 400 will be described as being performed by a system of one or more computers located in one or more locations. For example, a training system, e.g., the training system 100 of FIG. 1, appropriately programmed in accordance with this specification, can perform the process 400.

The system can evaluate the reinforcement learning objective function for a plurality of example interactions (step 402).

As described above, the system can use any of a variety of reinforcement learning techniques to train the target generative machine learning model by using an appropriate objective function for the technique. Some examples of reinforcement learning techniques and objective functions for reinforcement learning techniques include those described by Sutton, Richard S., et al in “Policy Gradient Methods for Reinforcement Learning with Function Approximation”, Advances in Neural Information Processing Systems 12 (1999); Schulman, John, et al. in “Proximal Policy Optimization Algorithms”, arXiv preprint arXiv: 1707.06347 (2017); Mnih, Volodymyr, et al. in “Asynchronous Methods for Deep Reinforcement Learning”, International Conference on Machine Learning, PmLR, 2016; and Schulman, John, et al. in “High-Dimensional Continuous Control Using Generalized Advantage Estimation”, arXiv preprint arXiv: 1506.02438 (2015).

As part of evaluating the reinforcement learning objective function for a particular reinforcement learning technique, the system can evaluate one or more preference-based value functions for the technique.

For example, the system can evaluate a value function V^{π,π′} of interactions for the multi-turn machine learning task defined following:

$${V}^{π , {π}^{′}} ( {x}_{h} ) = {𝔼}_{{x}_{f} ∼ π} [ {𝔼}_{{x}_{f}^{′} ∼ {π}^{′}} [ P ( {x}_{f} > {x}_{f}^{′} ) ] \vert {x}_{h} ]$$

Where xₕ is an input state of an example interaction at an h-th time step of the example interaction, π is a distribution of model outputs defined by the target generative machine learning model, π′ is a distribution of model outputs defined by a reference machine learning model, and

$${𝔼}_{{x}_{f} ∼ π} [ {𝔼}_{{x}_{f}^{′} ∼ {π}^{′}} [ P ( {x}_{f} > {x}_{f}^{′} ) ] \vert {x}_{h} ]$$

measures an expected probability that a final state, x_{f}, of the example interaction generated using the target generative machine learning model starting from the input state xₕ is preferred to a final state,

$${x}_{f}^{′} ,$$

of a reference interaction generated by the reference machine learning model.

As another example, the system can evaluate a state-action value function (e.g., a Q-function) Q^{π,π′} of interactions for the multi-turn machine learning task defined following:

$${Q}^{π , {π}^{′}} ( {x}_{h} , {y}_{h} ) = {𝔼}_{{x}_{f} ∼ π} [ {𝔼}_{{x}_{f}^{′} ∼ {π}^{′}} [ P ( {x}_{f} > {x}_{f}^{′} ) ] \vert {x}_{h} , {y}_{h} ]$$

Where yₕ is a model output for the multi-turn machine learning task at the h-th time step of the example interaction and

$${𝔼}_{{x}_{f} ∼ π} [ {𝔼}_{{x}_{f}^{′} ∼ {π}^{′}} [ P ( {x}_{f} > {x}_{f}^{′} ) ] \vert {x}_{h} , {y}_{h} ]$$

measures an expected probability that a final state, x_{f}, of the example interaction is preferred to a final state,

$${x}_{f}^{′} ,$$

of a reference interaction generated by the reference machine learning model when the target generative machine learning model generates the model output yₕ at the h-th time step of the example interaction.

As another example, the system can evaluate an advantage function A^{π,π′} of interactions for the multi-turn machine learning task defined following:

$${A}^{π , {π}^{′}} ( {x}_{h} , {y}_{h} ) = {Q}^{π , {π}^{′}} ( {x}_{h} , {y}_{h} ) - {V}^{π , {π}^{′}} ( {x}_{h} )$$

In some implementations, to limit a difference between the target generative machine learning model and a regularization machine learning model, the system can evaluate one or more regularized preference-based value functions

$${V}_{α}^{π , {π}^{′}} , {Q}_{α}^{π , {π}^{′}} ,$$

and/or

$${A}_{α}^{π , {π}^{′}} ,$$

defined following:

$${V}_{α}^{π , {π}^{′}} ( {x}_{h} ) = {𝔼}_{{x}_{f} ∼ π} [ {𝔼}_{{x}_{f}^{′} ∼ {π}^{′}} [ P ( {x}_{f} > {x}_{f}^{′} ) ] - α {\sum }_{t = h}^{H} KL ( π ( {y}_{t} \vert {x}_{t} ) \vert \vert μ ( {y}_{t} \vert {x}_{t} ) ) \vert {x}_{h} ]$$

$${Q}_{α}^{π , {π}^{′}} ( {x}_{h} , {y}_{h} ) = {𝔼}_{{x}_{f} ∼ π} [ {𝔼}_{{x}_{f}^{′} ∼ {π}^{′}} [ P ( {x}_{f} > {x}_{f}^{′} ) ] - α {\sum }_{t = h}^{H} KL ( π ( {y}_{t} \vert {x}_{t} ) \vert \vert μ ( {y}_{t} \vert {x}_{t} ) ) \vert {x}_{h} , {y}_{h} ]$$

$${A}_{α}^{π , {π}^{′}} ( {x}_{h} , {y}_{h} ) = {Q}_{α}^{π , {π}^{′}} ( {x}_{h} , {y}_{h} ) - {V}_{α}^{π , {π}^{′}} ( {x}_{h} )$$

Where a is a regularization coefficient and KL (π(yₜ|xₜ)∥μ(yₜ|xₜ)) is a Kullback-Liebler divergence between a distribution, π(yₜ|xₜ), of model outputs for the t-th time step of the example interaction determined by the target generative machine learning model and a regularization distribution, μ(yₜ|xₜ), of model outputs for the t-th time step of the example interaction (e.g., as determined by the regularization machine learning model).

By utilizing such preference-based value functions to update the target generative machine learning model, the system can train the target generative machine learning model so as to optimize a preference for interactions generated by the target generative machine learning model as compared to the reference interactions generated by the reference machine learning model. As illustrated by the experimental results presented in FIG. 5, evaluating preferences between interactions based on the final states of the interactions can enable the system to train the target generative machine learning model to perform the multi-turn machine learning task as compared to conventional reinforcement learning methods that optimize rewards for individual time steps of the interaction.

As described above, in some implementations, the reference machine learning model can be the target generative machine learning model and the system can generate reference interactions for each example interaction using the target generative machine learning model. When the system generates the reference interactions using the target generative machine learning model, the system can train the target generative machine learning model following a self-play procedure by evaluating the preference-based value functions as self-play value function,

$${V}_{α}^{π , π} , {Q}_{α}^{π , π} ,$$

and/or

$${A}_{α}^{π , π}$$

(e.g., an defined above with π′=π). By utilizing such a self-play training procedure, the system can train the target generative machine learning model to attain better performance in the multi-turn machine learning task utilizing preferences between interactions generated by the target generative machine learning model.

In some implementations, the system can evaluate such self-play value functions using a mixture distribution defined by both the target generative machine learning model and the regularization machine learning model. For example, the system can determine a mixture distribution, π^{τ}, defined following:

$${π}^{τ} ( {y}_{t} \vert {x}_{t} ) ∝ {π ( {y}_{t} \vert {x}_{t} )}^{1 - τ} {μ ( {y}_{t} \vert {x}_{t} )}^{τ}$$

Where τ is a mixture coefficient.

Evaluating self-play value functions

$${V}_{α}^{{π}^{τ} , {π}^{τ}} , {Q}_{α}^{{π}^{τ} , {π}^{τ}} ,$$

and/or

$${A}_{α}^{{π}^{τ} , {π}^{τ}}$$

(e.g., as defined above with π′=π=π^{τ}) using such a mixture distribution can provide further regularization, which can enable the system to better train the target generative machine learning model, as illustrated by the experimental results presented in FIG. 5.

As part of evaluating such preference-based value functions, the system can use preference measures for the example interactions (e.g., as determined following step 308 of the process 300 described above with reference to FIG. 3) as estimates of the expected probabilities,

$${𝔼}_{{x}_{f}^{′} ∼ {π}^{′}} [ P ( {x}_{f} > {x}_{f}^{′} ) ] ,$$

that the final states of the example interactions are preferred to the final states of the reference interactions.

In some implementations, the system can process the model inputs and, optionally, the model outputs for the example interactions using a critic model to predict a state value function,

$${V}_{α , ϕ}^{π , {π}^{′}} .$$

The system can use the preference measures for the example interactions and the values predicted by the critic model to evaluate the advantage function,

$${A}_{α}^{π , {π}^{′}} ,$$

for the example interactions, as described in more detail by Schulman, John, et al. in “High-Dimensional Continuous Control Using Generalized Advantage Estimation”, arXiv preprint arXiv: 1506.02438 (2015). As described below, the system can train the critic model using the preference measures for the example interactions.

As a particular example, when the system trains the target generative machine learning model following a self-play procedure, the objective function can measure a loss for each example interaction defined by

$$ℒ ( {x}_{1 : H} , {y}_{1 : H} ) = {\sum }_{h = 1}^{H} - {A}_{α}^{π , π} ( {x}_{h} , {y}_{h} ) log {π}_{θ} ( {y}_{h} \vert {x}_{h} ) + α KL ( {π}_{θ} ( \cdot \vert {x}_{h} ) \vert \vert μ ( \cdot \vert {x}_{h} ) \} )$$

Where x_{1:H} are the model inputs for the example interaction and y_{1:H} are the model outputs for the example interaction over H time-steps of the example interaction.

The system can update the target machine learning function to optimize the objective function (step 404). As part of optimizing the objective function, the system can determine a gradient (e.g., a policy gradient) of the objective function with respect to parameters of the target generative machine learning model. The system can update the parameters of the target generative machine learning model using the gradient of the objective function following any appropriate machine learning technique (e.g., following stochastic gradient descent, ADAM, etc.).

When the system uses a critic model as part of evaluating the objective function for the target generative machine learning model, the system can also update the critic model using the preference measures for the example interactions (step 406). In particular, the system can update the parameters of the critic model to optimize a loss function for the critic model. For example, the loss function for the critic model can measure a loss for each model input, xₕ, of each example interaction defined by:

$${ℒ}_{critic} ( {x}_{h} ) = {( {\hat{V}}_{α}^{π , π} ( {x}_{h} ) - {\hat{V}}_{α , ϕ}^{π , π} ( {x}_{h} ) )}^{2}$$

Where

$${\hat{V}}_{α}^{π , π} ( {x}_{h} )$$

is an estimate or the value function for the input xₕ determined using the preference measure for the example interaction, e.g., as described by Schulman, John, et al. in “High-Dimensional Continuous Control Using Generalized Advantage Estimation”, arXiv preprint arXiv: 1506.02438 (2015).

As part of optimizing the loss function for the critic model, the system can determine a gradient of the loss function for the critic model with respect to parameters of the critic model. The system can update the parameters of the critic model using the gradient of the loss function for the critic model following any appropriate machine learning technique (e.g., following stochastic gradient descent, ADAM, etc.).

FIG. 5 illustrates a performance of example generative machine learning models that have been trained using the described methods. In particular, FIG. 5 illustrates results of side-by-side comparisons between outputs interactions for an education dialogue task generated by generative machine learning models trained using the methods described in this specification (referred to as “MTPO-T” and “MTPO” in FIG. 5 for implementations that evaluate value functions with and without a mixture distribution with a regularization distribution), using supervised fine tuning (SFT), using reinforcement learning from human feedback (RLHF), and using Nash learning from human feedback (Nash). The entry for each row and column of the table illustrated in FIG. 5 provides a probability at which an interaction generated using a model trained using the method of the row for the entry is preferred in a side-by-side comparison with an interaction generated using a model trained using the method of the column for the entry.

Nash learning from human feedback is a technique for fine tuning a generative model using human feedback for individual outputs of the generative model. A method of performing Nash learning from human feedback is described by Munos, Rémi, et al. in “Nash Learning from Human Feedback”, arXiv preprint arXiv: 2312.00886 18 (2023).

A method of performing RLHF is described by Ouyang, Long, et al. in “Training Language Models to Follow Instructions with Human Feedback.” Advances in Neural Information Processing Systems 35 (2022): 27730-27744.

For the education dialogue task, a teacher (agent) is faced with the task of teaching a student (environment) about a given topic. The interactions for the education dialogue task are conversations between the teacher and student. A language model representing the teacher is prompted with a learning topic in science, history, etc. A language model representing the student is prompted with the characteristics of its learning habits, e.g., prefers interactive learning, lecture-based learning or hands-on activities. Preference measures between interactions are determined by processing the interactions using a language model that is prompted with instructions that define a good learning interaction.

As illustrated in FIG. 5, the interactions generated by the models trained using the methods described in this specification are more often preferred in side-to-side comparison to the outputs generated by the models trained using SFT, RLHF, and Nash learning from human feedback.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, or a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
training a target generative machine learning model, the training comprising, at each of a sequence of training iterations:
obtaining a plurality of example interactions for the training iteration, wherein each example interaction starts from a respective initial model input and comprises, for each of a plurality of time steps of the example interaction: (i) an example model input for the time step of the example interaction and (ii) an example model output for the time step of the example interaction;
obtaining, for each example interaction of the plurality of example interactions, one or more reference interactions, wherein:
each of the one or more reference interactions for the example interaction starts from the same respective initial model input as the example interaction and comprises, for each of a plurality of time steps of the reference interaction: (i) a reference model input for the time step of the reference interaction and (ii) a reference model output for the time step of the reference interaction;
determining, for each example interaction of the plurality of example interactions, a preference measure for the example interaction, wherein the preference measure for the example interaction is based on a comparison between the example interaction and the one or more reference interactions for the example interaction; and
updating the target generative machine learning model using a machine learning technique to optimize an objective function, wherein the objective function includes the preference measures for the plurality of example interactions.

2. The method of claim 1, wherein the objective function is based on, for each of the plurality of example interactions, the preference measure for the example interaction and a likelihood of generating the example interaction by processing the initial model input for the example interaction using the target generative machine learning model.

3. The method of claim 1, wherein, for each of the training iterations, obtaining the one or more reference interactions for each example interaction of the plurality of example interactions comprises:
for each of the plurality of time steps of the reference interaction:
obtaining the reference model input for the time step of the reference interaction; and
generating the reference model output for the time step of the reference interaction by processing the reference model input for the time step of the reference interaction using a reference generative machine learning model for the training iteration.

4. The method of claim 3, wherein training the target generative machine learning model further comprises at a start of each training iteration of the sequence of training iterations:
initializing a set of parameters for the reference machine learning model for the training iteration using a current set of parameters for the target generative machine learning model as of the training iteration.

5. The method of claim 4, wherein, for each of the training iterations, obtaining the plurality of example iterations comprises, for each example interaction of the plurality of example interactions:
for each of the plurality of time steps of the example interaction:
obtaining the example model input for the time step of the example interaction; and
generating the example model output for the time step of the example interaction by processing the example model input for the time step of the example interaction using the target generative machine learning model in accordance with the current set of parameters for the target generative machine learning model as of the training iteration.

6. The method of claim 5, wherein, for each time step after a first time step of the plurality of time steps of the example interaction, obtaining the example model input for the time step of the example interaction comprises:
generating the example model input for the time step of the example interaction by processing the example model output for a preceding time step of the example interaction using the target generative machine learning model in accordance with the current set of parameters for the target generative machine learning model as of the training iteration.

7. The method of claim 3, wherein the objective function includes a term measuring, for each of the initial model inputs of the example interactions, a difference between a distribution of interactions determined by processing the initial model input using the target generative machine learning model and a distribution of interactions determined by processing the initial model input using the reference generative machine learning model for the training iteration.

8. The method of claim 1, wherein the objective function includes a term measuring, for each of the initial model inputs of the example interactions, a difference between a distribution of interactions determined by processing the initial model input using the target generative machine learning model and a regularization distribution of interactions for the initial model input.

9. The method of claim 1, wherein, for each example interaction of the plurality of example interactions, determining the preference measure for the example interaction comprises:
obtaining data characterizing a human preference between the example interaction and the one or more reference interactions for the example interaction.

10. The method of claim 1, wherein, for each example interaction of the plurality of example interactions, determining the preference measure for the example interaction comprises, for each of the one or more reference interactions for the example interaction:
processing data characterizing the example interaction and data characterizing the reference interaction using a preference prediction machine learning model to generate a predicted preference between the example interaction and the reference interaction.

11. The method of claim 10, wherein:
the preference prediction machine learning model is a generative machine learning model; and
processing the data characterizing the example interaction and the data characterizing the reference interaction using a preference prediction machine learning model to generate the predicted preference between the example interaction and the reference interaction comprises:
processing (i) a prompt for the preference prediction machine learning model, (ii) the data characterizing the example interaction, and (iii) the data characterizing the reference interaction using the preference prediction machine learning model to generate the predicted preference between the example interaction and the reference interaction, wherein the prompt for the preference prediction machine learning model comprises a request to predict a preference between the example interaction and the reference interaction.

12. The method of claim 1, wherein, for each example interaction:
the example interaction comprises a final state for the example interaction;
for each of the one or more reference interactions for the example interaction, the reference interaction comprises a final state for the reference interaction; and
the preference measure for the example interaction is based on a comparison between the final state for the example interaction and the final states for the one or more reference interactions for the example interaction.

13. The method of claim 1, wherein:
the target generative model is configured to perform a sequential machine learning task; and
for each training iteration and each of the plurality of example interactions for the training iteration:
the example interaction comprises example model outputs generated by the target generative model to perform the sequential machine learning task; and
each of the one or more reference interactions for the example interaction comprises reference model outputs for performing the sequential machine learning task.

14. The method of claim 13, wherein, for each example interaction, the preference measure for the example interaction is based on a comparison between respective performance measures of the sequential machine learning task for the example interaction and for the one or more reference interactions for the example interaction.

15. The method of claim 1, wherein:
the target machine learning model is configured to process input token sequences to generate corresponding output token sequences, wherein the input token sequence and the output token sequence comprise tokens from a vocabulary of tokens for the target machine learning model; and
for each training iteration and for each of the plurality of example interactions of the training iteration:
each example model input for the example interaction comprises a respective example input token sequence; and
each example model output for the example interaction comprises a respective example output token sequence.

16. The method of claim 1, wherein:
the target machine learning model is configured to interact with a user;
for each example interaction, one or more example model inputs for the example interaction comprises an example of a query from an example user for the example interaction; and
for each example interaction, one or more example model outputs for the example interaction comprises a response to a respective example of a query from the example user for the example interaction.

17. The method of claim 1, wherein:
the target machine learning model is configured to select actions for an agent interacting with an environment to perform a task in the environment; and
for each example interaction, one or more example model outputs for the example interaction comprises a selected action for an example agent to perform the task in an example environment for the example interaction.

18. The method of claim 1, further comprising, after training the target generative model:
receiving a model input; and
processing the model input using the target generative model to generate a model output.

19. A system comprising:
one or more computers; and
one or more storage devices communicatively coupled to the one or more computers, wherein the one or more storage devices store instructions that, when executed by the one or more computers, cause the one or more computers to perform operations comprising:
training a target generative machine learning model, the training comprising, at each of a sequence of training iterations:
obtaining a plurality of example interactions for the training iteration, wherein each example interaction starts from a respective initial model input and comprises, for each of a plurality of time steps of the example interaction: (i) an example model input for the time step of the example interaction and (ii) an example model output for the time step of the example interaction;
obtaining, for each example interaction of the plurality of example interactions, one or more reference interactions, wherein:
each of the one or more reference interactions for the example interaction starts from the same respective initial model input as the example interaction and comprises, for each of a plurality of time steps of the reference interaction: (i) a reference model input for the time step of the reference interaction and (ii) a reference model output for the time step of the reference interaction;
determining, for each example interaction of the plurality of example interactions, a preference measure for the example interaction, wherein the preference measure for the example interaction is based on a comparison between the example interaction and the one or more reference interactions for the example interaction; and
updating the target generative machine learning model using a machine learning technique to optimize an objective function, wherein the objective function includes the preference measures for the plurality of example interactions.

20. One or more non-transitory computer storage media storing instructions that when executed by one or more computers cause the one or more computers to perform operations comprising:
training a target generative machine learning model, the training comprising, at each of a sequence of training iterations:
obtaining a plurality of example interactions for the training iteration, wherein each example interaction starts from a respective initial model input and comprises, for each of a plurality of time steps of the example interaction: (i) an example model input for the time step of the example interaction and (ii) an example model output for the time step of the example interaction;
obtaining, for each example interaction of the plurality of example interactions, one or more reference interactions, wherein:
each of the one or more reference interactions for the example interaction starts from the same respective initial model input as the example interaction and comprises, for each of a plurality of time steps of the reference interaction: (i) a reference model input for the time step of the reference interaction and (ii) a reference model output for the time step of the reference interaction;
determining, for each example interaction of the plurality of example interactions, a preference measure for the example interaction, wherein the preference measure for the example interaction is based on a comparison between the example interaction and the one or more reference interactions for the example interaction; and
updating the target generative machine learning model using a machine learning technique to optimize an objective function, wherein the objective function includes the preference measures for the plurality of example interactions.
